(19) United States
(12) Patent Application Publication
(10) Pub. No.: US 2012/0159524 A1
(43) Pub. Date: Jun. 21, 2012

(54) USER EQUIPMENT HAVING A GENERAL EDITING FUNCTION AND METHOD THEREOF

(76) Inventor: Ha-Yong KIM, Seoul (KR)

(21) Appl. No.: 13/279,600

(22) Filed: Oct. 24, 2011

(30) Foreign Application Priority Data
Dec. 21, 2010 (KR) 10-2010-0131818

(51) Int. Cl. G06F 9/46

(52) U.S. Cl. 719/328

(57) ABSTRACT

Apparatus and method for supporting a general editor function. User data may be received from a user and transferred to at least one application selected from an application list provided to the user. The user data may be stored in a memory, fetched from the memory in response to a user control signal, and transferred to one application or multiple applications. The transferred user data may be modified based on properties and functions of the selected at least one application.

### CROSS REFERENCE TO PRIOR APPLICATIONS

The present application claims priority under 35 U.S.C. §119 to Korean Patent Application No. 10-2010-0131818 (filed on Dec. 21, 2010), which is hereby incorporated by reference in its entirety.

### FIELD OF THE INVENTION

Apparatuses and methods consistent with the present invention relate to supporting a general editing function, and more particularly, to enabling a user to conveniently input data to various types of applications using a general editor function.

### BACKGROUND OF THE INVENTION

A user equipment has been advanced to perform multiple functions such as communicating with others, exchanging text messages or multimedia messages, sending e-mails, capturing a still image or a moving image, playback of a music file or a video file, playing a game, and a receiving a broadcasting signal. Lately, such a multifunctional user equipment has been receiving greater attention. Instead of using multiple independent devices, a user prefers to use one multifunctional user equipment.

In order to implement such various functionalities in single user equipment, many studies have been made for developing various applications and user interfaces in hardware and software for interacting with inputs from users. An application may be referred to commonly as an application software. For example, an application may be installed in a user equipment and provide a unique user interface to receive data from a user. An e-mail application may provide a graphical user interface (GUI) having a window for a user to enter and modify text data. A Short Message Service (SMS) application or a Multimedia Message Service (MMS) application may also provide a GUI with a window for a user to enter and modify text or multimedia data.

Occasionally, a user may need to enter the same text two or more times when the user desires to send the same message through both an SMS message and an e-mail. It may be inconvenient for the user to enter the same text repeatedly when the user desires to send the same text using different application software. Accordingly, there is a need for improvements in the way of entering user input data to multiple application software.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a user equipment may support a general editor function that may enable a user to conveniently input data to a selected one of a plurality of applications.

In accordance with another aspect of the present invention, a user equipment may support a general editor function that may enable a user to conveniently enter the same input data to share across multiple applications.

In accordance with an embodiment of the present invention, user data may be received through a general editor function, and then transferred to at least one application.

Prior to transferring the received user data, at least one application list may be provided to a user from which the at least one application is selected. Each application list of the at least one application list may include at least one application that is capable of interacting with the general editor function to receive the transferred user data.

Each application list of the at least one application list may be classified by an input type, and the at least one application list may include at least one of a text input related application list including at least one application configured to receive text as the user data, a voice input related application list including at least one application configured to receive voice as the user data, and an image input related application list including at least one application configured to receive an image as the user data.

After the receiving user data, the user data may be stored, and the stored user data may be fetched in response to a user control signal. At least one application may be selected from at least one application list and the fetched user data may be transferred to the selected at least one application or to a plurality of applications.

After the received user data is transferred to the at least one application, the transferred user data may be modified based on properties and functions of the at least one application.

In accordance with another embodiment of the present invention, a general editor user interface may be displayed on a display module of the user equipment. User data input from a user may be received through a data input window of the general editor user interface. An application list may be displayed on the general editor user interface. Based on a user selection signal, a user interface of an application selected from the application list may be displayed on the display module. The user data received through the general editor user interface may be transferred to the selected application.

After the receiving user data, the received user data may be stored in a memory. The stored user data may be fetched after displaying the user interface of the selected application and the fetched user data may be transferred to the selected application. The stored user data may be fetched and transferred to a plurality of applications selected from the application list.

The application list may include at least one application that interacts with the general editor function. The application list may be classified by an input data type, and the application list may include at least one of a text input related application list including at least one application configured to receive text as the user data, a voice input related application list including at least one application configured to receive voice as the user data, and an image input related application list including at least one application configured to receive an image as the user input data.

After transferring the user data to the selected application, the transferred user data may be modified based on properties and functions of the selected application.

In accordance with still another embodiment of the present invention, an apparatus may support a general editor function. The apparatus may include a display module and a general editor module. The display module may be configured to display a general editor user interface of the general editor function. The general editor module may be configured to receive user data from a user through a data input window of the general editor user interface, and configured to transfer the user data to at least one application selected from at least one application list.

The apparatus may further include a button configured to receive an activation signal for activating the general editor function, and an input unit which, in integration with the data input window of the general editor user interface, is configured to receive the user data from the user. The input unit may include at least one of a camera, a microphone, a touch pad, a keypad, and a dome switch.

The display module may include a touch screen, and a general editor icon may be displayed on an area of the display module as an activation key for activating the general editor function.

The apparatus may further include a data storage unit and an application group. The data storage unit may be configured to store the user data received through the general editor user interface. The application group may include a plurality of application modules each controlling an operation for a corresponding application.

The general editor module may be configured to display an application list on the general editor user interface, receive a selection signal from the user to select the at least one application from the at least one application list, transfer the received user data to the selected at least one application, and display a user interface of the selected at least one application along with the transferred user input data. The transferred user data may be modified based on properties and functions of the selected at least one application.

The general editor module may be configured to store the received user data in the data storage unit, fetch the stored user data, and transfer the fetched user data to at least one application. The user data may be transferred to a plurality of applications selected from the at least one application list.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a user equipment including a general editor module, in accordance with an embodiment of the present invention;

FIG. 2 illustrates, in more detail, a controller of the user equipment illustrated in FIG. 1, in accordance with an embodiment of the present invention;

FIG. 3 illustrates a method for supporting a general editor function, in accordance with an embodiment of the present invention;

FIGS. 4A and 4B illustrate examples of supporting a general editor function, in accordance with an embodiment of the present invention;

FIGS. 5A to 5C illustrate examples of supporting a general editor function, in accordance with another embodiment of the present invention;

FIGS. 6A and 6B illustrate examples of supporting a general editor function, in accordance with another embodiment of the present invention; and

FIGS. 7A and 7B illustrate examples of supporting a general editor function, in accordance with another embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

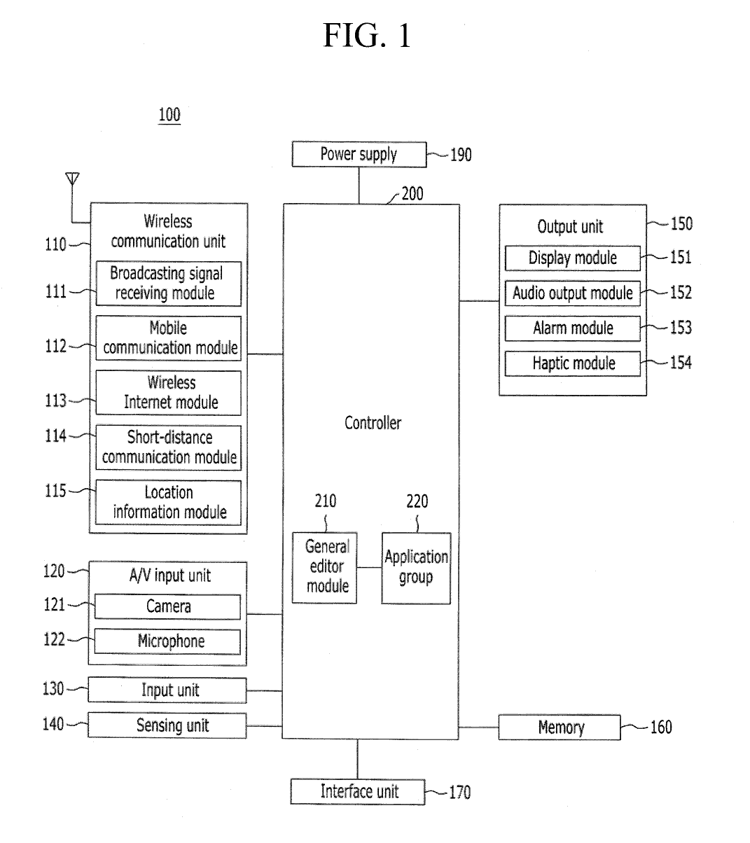

FIG. 1 illustrates a user equipment including a general editor module, in accordance with an embodiment of the present invention.

In accordance with an embodiment of the present invention, a user equipment may support a general editor function. A general editor function may provide a user interface to receive user input data from a user and transfer the user input data to a selected one of multiple applications in the user equipment. In order to support the general editor function, the user equipment in accordance with an embodiment of the present invention may include a general editor module as well as other constituent elements. Hereinafter, constituent elements of a user equipment will be described in detail with reference to FIG. 1.

Referring to FIG. 1, the user equipment 100 may include a wireless communication unit 110, an audio/video (A/V) input unit 120, an input unit 130, a sensing unit 140, an output unit 150, a memory 160, an interface unit 170, a power supply 190, and a controller 200. The controller 200 may include a general editor module 210 and an application group 220.

The wireless communication unit 110 may include at least one module for wireless communication between the user equipment 100 and a wireless communication system or between the user equipment 100 and a network in the vicinity of the user equipment 100. For example, the wireless communication unit 110 may include any or all of a broadcasting signal receiving module 111, a mobile communication module 112, a wireless Internet module 113, a short-distance communication module 114, and a location information module 115.

The broadcasting signal receiving module 111 may receive a broadcasting signal and/or broadcasting related information from an external source such as a broadcasting management server through a broadcasting channel. The broadcasting channel may be a satellite channel or a terrestrial channel. The broadcasting management server may be a server that is provided with a broadcasting signal and/or broadcasting related information and may transmit the broadcasting signal and/or broadcasting related information to user equipments. The broadcasting signal may include any or all of a TV broadcasting signal, a radio broadcasting signal, and a data broadcasting signal. The broadcasting related information may be information related to a broadcasting channel, a broadcasting program, or a broadcasting service provider. The broadcasting related information may be provided through a mobile communication network. In accordance with an embodiment of the present invention, the broadcasting related information may be received through the mobile communication module 112. The broadcasting related information may have various types of formats. For example, the broadcasting related information may have a format of an Electronic Program Guide (EPG) of the Digital Multimedia Broadcasting (DMB) or an Electronic Service Guide (ESG) of the Digital Video Broadcast-Handheld (DVB-H).

The broadcasting signal receiving module 111 may receive a broadcasting signal from any of various broadcasting systems. For example, the broadcasting receiving module 111 may use a Digital Multimedia Broadcasting-Terrestrial (DMB-T) system, a Digital Multimedia Broadcasting-Satellite (DMB-S) system, a Media Forward Link Only (Media FLO) system, a Digital Video Broadcast-Handheld (DVB-H) system, and an Integrated Services Digital Broadcast-Terrestrial (ISDB-T) system. The broadcasting signal receiving module 111 may be configured to receive a broadcasting signal from other systems as well as from the above described digital broadcasting systems. The broadcasting signal receiving module 111 may store broadcasting signals and/or broadcasting related information in the memory 160.

The mobile communication module 112 may receive a wireless signal from and/or transmit a wireless signal to at least one of base stations, user equipments, and servers in a mobile communication network. The wireless signal may include data in various formats according to a type of the wireless signal, such as a voice call signal, a video call signal, a text message, and a multimedia message.

The wireless Internet module 113 may be a module for wirelessly accessing the Internet. The wireless Internet module 113 may be internally included in the user equipment 100 or externally coupled to the user equipment 100. The wireless Internet module 113 may support various types of technologies for accessing the Internet, such as Wireless Local Area Network (WLAN), Wi-Fi, Wireless broadband (WiBro), World Interoperability for Microwave Access (WiMAX), and High Speed Downlink Packet Access (HSDPA), but is not limited thereto.

The short-distance communication module 114 may be a module for a short-distance communication. The short-distance communication module 114 may support related technologies, for example, Bluetooth, Radio Frequency Identification (RFID), Infrared Data Association (IrDA), Ultra Wideband (UWB), ZigBee, and Near Field Communication (NFC), but is not limited thereto.

The location information module 115 may be a module for finding a location of the user equipment 100 and providing information related to the location thereof. The location information module 115 may be a global positioning system (GPS), but is not limited thereto. For example, the location information module 115 may provide three dimensional location data of a location of the user equipment 100, such as latitude, longitude, and altitude of the user equipment 100. Such information may be calculated using various methods. For example, the location information module 115 may calculate distances from three different satellites to the user equipment 100 and times of measuring distances and calculates a location of the user equipment by applying triangulation on the calculated distances and times. For another example, the location information module 115 may calculate location and time information using three satellites and calibrate the location and time information using another satellite. The location information module 115 may constantly calculate a current location of the user equipment 100 in real-time and calculate a speed of the user equipment 100 based on the calculated locations.

The A/V input unit 120 may receive an audio signal and/or a video signal. The A/V input unit 120 may include a camera 121 and a microphone 122.

The camera 121 may process image frames of a still image or a moving image, which are captured by an image sensor in a video call mode or a photographing mode. The processed image frame may be displayed on a display module of the user equipment 100 through a display module 151 of the output unit 150. The image frames captured from the camera 121 may be stored in the memory 160 or transmitted to an external device through the wireless communication unit 110. In accordance with an embodiment of the present invention, the user equipment 100 may include a plurality of cameras.

The microphone 122 may receive an audio signal provided externally in an on-call mode, a recording mode, or a voice recognition mode. In the case of the on-call mode, audio data may be converted to a data format that can be transmitted to a mobile communication base station through the mobile communication module 112. The microphone 122 may be implemented with various noise filtering algorithms for eliminating noise generated in the background during the receiving of the external audio signals.

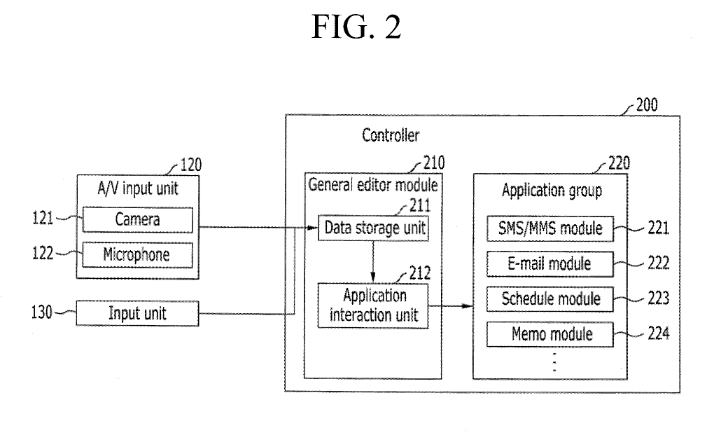

The input unit 130 may be a user interface for receiving input from a user. Such an input unit 130 may be realized as various types. For example, the input unit 130 may include any of a keypad, a dome switch, a touch pad, a jog wheel, and a jog switch, but is not limited thereto. The input unit 130 may include at least one operation unit for inputting commands in order to control the operation of the user equipment 100. For example, the input unit 130 may include a call start button 131 and a volume control button 132, as illustrated in FIG. 2. Particularly, user equipments may include a touch screen as a display module in order to satisfy demands of expanding a display screen, making better use of a space, and improving design. When a user equipment employs a touch screen, the input unit 130 may be integrally realized with the display module 151. For example, the input unit 130 may be realized as a soft key type input unit on a display module of the user equipment 100.

The sensing unit 140 may detect a current status of the user equipment 100. For example, the sensing unit 140 may sense an opening or closing of a cover of the user equipment 100, a location and a bearing of the user equipment 100, acceleration and deceleration of the user equipment 100, or physical contact with or proximity to a user. Based on the detected status of the user equipment 100, the sensing unit 140 may generate a sensing signal to control the operation of the user equipment 100. For example, in the case of a mobile phone having a sliding type cover, the sensing unit 140 may sense whether a cover is opened or closed. The sensing unit 140 may sense whether or not the power supply 190 supplies power or whether or not the interface unit 170 is coupled to an external device.

The output unit 150 may generate visual outputs, audio outputs, and/or haptic outputs. The output unit 150 may include a display module 151, an audio output module 152, an alarm module 153, and a haptic module 154.

The display module 151 may output information processed by the user equipment 100. For example, in the case of an on-call mode, the display module 151 may display a user interface (UI) or a graphical user interface (GUI) according to a type of a call. In the case of a video call mode or a photographing mode, the display module 151 may display a UI or a GUI related to receive video or display captured image or video. The display module 151 may be a liquid crystal display (LCD), a thin film transistor LCD (TFT LCD), an organic light emitting diode (OLED), a flexible display, or a 3D display, but is not limited thereto. In accordance with an embodiment of the present invention, the user equipment 100 may include a plurality of display modules. For example, a plurality of display modules may be disposed on one side of the user equipment 100 with a gap between adjacent display modules or without a gap. Additionally, a plurality of display modules may be disposed on different sides of the user equipment 100.

The user equipment 100 may employ a touch screen to form the display module 151. The touch screen may have a layered structure formed of a display module and a touch sensor disposed over or under the display module. Accordingly, the display module 151 may be used not only as an output device but also as an input device when the touch screen is employed as a component of the display module 151. A method for rotating a displayed image in accordance with an embodiment of the present invention will be described based on a user equipment employing a touch screen as a component of the display module 151.

The touch sensor may be in a form of a touch film, a touch sheet, or a touch pad. The touch sensor may convert pressure applied to a specific part of the display module 151 and capacitance variation formed around a specific part of the display module 151 in accordance with an electric input signal. The touch sensor may detect pressure and/or a directivity of a touch input as well as a location and/or an area of a touch input made on a touch sensor. When the touch sensor senses a touch input, the touch sensor may transmit a corresponding signal to a touch controller. The touch controller may process the signal from the touch sensor and transmit corresponding data to the controller 200. Accordingly, the controller 200 can be aware of which part of a display module has been touched.

A proximity sensor may be disposed in an internal area surrounded by the touch screen or disposed near, around or throughout the touch screen. The proximity sensor is a sensor that may detect an object without a physical contact. For example, the proximity sensor may detect an object approaching a sensing side of the proximity sensor or detect an object located in the vicinity of the proximity sensor using an electromagnetic field or infrared rays. The proximity sensor may have a longer lifespan and higher utilization degree than that of a contact-type sensor. For example, the proximity sensor may be a through-beam photoelectric sensor, a retro-reflective photoelectric sensor, a capacitive proximity sensor, or a magnetic proximity sensor, but is not limited thereto. A capacitive touch screen may be configured to detect an approaching pointer based on electromagnetic variation that may be caused by the pointer approaching the touch screen. Such a capacitive touch screen (touch sensor) may be classified as a type of proximity sensor.

The proximity sensor may sense a proximity touch and/or a proximity touch pattern, for example, a proximity touch distance, a proximity touch direction, a proximity touch speed, a proximity touch time, a proximity touch location, and/or a proximity touch movement state. Information on proximity touch inputs or proximity touch patterns may be displayed on a touch screen.

The audio output module 152 may output audio data stored in the memory 160 or received from the wireless communication unit 110 in an on-call mode, in a recording mode, in a voice recognition mode, and/or in a broadcasting receiving mode. The audio output module 152 may output an audio signal corresponding to functions performed by the user equipment 100. For example, the audio output module 152 may output a call-signal receiving sound or a message receiving sound. Such an audio output module 152 may include a speaker.

The alarm module 153 may output a signal in order to inform a user of event generation in the user equipment 100. For example, the user equipment 100 may generate events such as call signal reception, message reception, key signal input, and/or touch input. The alarm module 153 may output various types of signals such as a video signal, an audio signal, and/or a vibration signal in order to inform a user of the event generation. The video signal and the audio signal may be output through the display module 151 and the audio output module 152 respectively. Furthermore, in an embodiment of the present invention, the user equipment 100 may include a plurality of audio output modules.

The haptic module 154 may generate various types of haptic effects that a user may sense. Particularly, the haptic module 154 may generate vibration. The haptic module 154 may control strength or pattern of vibration. For example, the haptic module 154 may output a vibration effect having different types of vibrations combined together or may output different types of vibrations sequentially. Instead of vibration, the haptic module 154 may generate various types of other effects. For example, the haptic module 154 may generate an effect that stimulates a skin of a user by controlling a pin array with each pin independently moving vertically. The haptic module 154 may generate an effect that stimulates a skin of a user by controlling an air outlet to spray out a burst of air to a user or by controlling an air inlet to intake air from around a user. Furthermore, the haptic module 154 may generate an electrostatic force, a cold sensation, or a warm sensation to stimulate a user.

The haptic module 154 may transfer a haptic effect through direct physical contact or through a muscle sense of a finger or an arm of a user. In accordance with an embodiment of the present invention, the user equipment 100 may include a plurality of haptic modules.

The memory 160 may store programs for operations of the controller 200 and input/output data. For example, the memory 160 may store various data such as contact lists, e-mails, messages, pictures, video files, various vibration patterns and effect sounds in response to a touch input made on the touch screen. In accordance with an embodiment of the present invention, the memory 160 may store programs and data for rotating a displayed image.

The memory 160 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. In accordance with an embodiment of the present invention, the user equipment 100 may interact with a web-based storage that performs the storage function of the memory 160.

The interface unit 170 may include a communication path between the user equipment 100 and an external device or devices coupled to the user equipment 100. The interface unit 170 may receive data or power from an external device, transfer the data to a constituent element of the user equipment 100 or transfer internal data of the user equipment 100 to an external device. For example, the interface unit 170 may include a wired/wireless headset port, an external power charger port, a wired/wireless data port, a memory card port, an identification module connection port, an audio I/O port, a video I/O port, and/or an earphone port. The identification module may be a chip for storing various types of information for authenticating a user right of the user equipment 100. The identification module may include a User Identify Module (UIM), a Subscriber Identity Module (SIM), and/or a Universal Subscriber Identity Module (USIM). A device having the identification module may be manufactured in the form of a smart card. Such a device may be coupled to the user equipment 100 through the identification module connection port.

The interface unit 170 may include a path for receiving power from a cradle or dock when the user equipment 100 is coupled to an external cradle or dock. The interface unit 170 may include a path for transferring command signals input to the cradle or dock by a user to the user equipment 100. A command signal or power input from the cradle or dock may operate as a signal that indicates to a user whether or not the user equipment 100 is accurately or firmly connected to the cradle or dock.

The power supply 190 may supply power for operating constituent elements in response to the controller 200. For example, the power supply 190 may receive power from an internal power source or from an external power source.

The controller 200 may control an overall operation of the user equipment 100. For example, the controller 200 may control and process a voice call, a text message, and a video call. The controller 200 may recognize a touch input made on the touch screen. For example, the controller 200 may process patterns of touch inputs made on the touch screen. Based on the processed patterns, the controller 200 may recognize a character or a symbol input through a touch screen. In accordance with an embodiment of the present invention, the controller 200 may include a general editor module 210 for supporting a general editor function.

The general editor module 210 may control operations related to a general editor function. For example, the general editor module 210 may receive an activation signal from a user and display a user interface on the output unit 150. The user interface may be displayed on the display module 151 of the output unit 150. The general editor module 200 may transfer the user data input to at least one of the multiple applications in the user equipment 100. The general editor module 200 will be described in more detail with reference to FIG. 2.

FIG. 2 illustrates, in more detail, a controller 200 of the user equipment illustrated in FIG. 1, in accordance with an embodiment of the present invention.

As described above, the general editor module 210 may perform operations for supporting a general editor function. The general editor module 210 may be included in the controller 200 of the user equipment 100, as illustrated in FIG. 1.

Referring to FIG. 2, the general editor module 210 may interact with an application group 220. Furthermore, the general editor module 210 may also interact with the user input unit 130 and the A/V input unit 120.

The general editor module 210 may control operations related to a general editor function. For example, the general editor module 210 may control operations for displaying a user interface on the display module 151, receiving user input data from a user, processing the received user input data, and transferring the processed user input data to a selected application, but is not limited thereto. Furthermore, the general editor module 210 may control operations for providing a list of applications capable of interacting with the general editor function and selecting an application from the list. The general editor module 210 may also support an editing tool.

The general editor module 210 may classify applications capable of interacting with the general editor function by a user input type and generate a list of applications based on the classification result. For example, the general editor module 210 may classify applications into text input related applications, voice input related applications, and image input related applications and generate a list of classified applications.

As illustrated in FIG. 2, the general editor module 210 may include a data storage unit 211 and an application interaction unit 212. The data storage unit 211 may temporarily store user input data. The application interaction unit 212 may interact with a plurality of application modules that can receive the user input data.

The data storage unit 211 may store at least one of a text data, an audio data, and an image data, which are input through the A/V input unit 120 or the input unit 130. A duration for storing user input data in the data storage unit 211 may be from a time that a user inputs data to a time that the general editor function transfers the user input data to a corresponding application. Alternatively, the data storage unit 211 may store the user input data until a user inputs a deletion control signal.

The user input data stored in the data storage unit 211 may be used for multiple applications. For example, a user input data for a short message service (SMS) application, which may be input through the general editor function and stored in the data storage unit 211, may be used for another application such as a schedule application.

The application interaction unit 212 may perform operations for interacting with a corresponding application module in the application group 220 in response to a user control signal when one of the application modules in the application group 220 is activated. The application interaction unit 212 may extract at least one of a text data, an audio data, and an image data stored in the data storage unit 211 and transfer the extracted data to a corresponding application module of the application group 220.

Referring to FIG. 2, the application group 220 may include a plurality of application modules each controlling operations related to a corresponding application capable of interacting with the general editor function. That is, the application modules in the application group 220 may control applications using the A/V input unit 120 and/or the input unit 130 as a data input means. For example, the application group 220 may include an SMS/MMS message application module 221, an e-mail application module 222, a schedule application module 223, and/or a Memo application module 224, but is not limited thereto. Each application module may receive a user input data from the general editor module 210 and reconfigure the received user input data based on properties and functions of a corresponding application.

Any application modules that can interact with the general editor function can be included in the application group 220 and receive user input data from the general editor function.

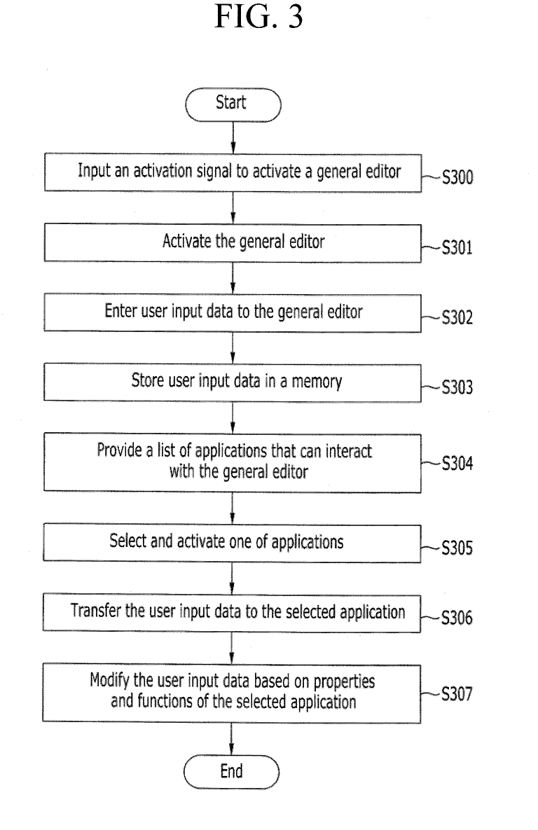

FIG. 3 illustrates a method for supporting a general editor function, in accordance with an embodiment of the present invention.

As described above, a general editor function may provide a user interface to receive user input data from a user and transfer the user input data to an application selected from one of multiple applications in the user equipment. The general editor function may be realized as application software that may be installed in a user equipment. The present invention, however, is not limited thereto. Hereinafter, a method for supporting the general editor function will be described with reference to FIG. 3.

Referring to FIG. 3, an activation signal may be input to activate a general editor S300. For example, a user may use keys and/or buttons of a user equipment to generate the activation signal. A key or a button of a user equipment may be set up as an activation button to activate the general editor. In the case of using a touch screen, the general editor may be activated by clicking a general editor icon displayed on a certain area of the touch screen.

In response to the activation signal, the general editor may be activated S301. For example, the general editor may provide a user interface to receive user input data from a user. The user interface may be a GUI displayed on a display module 151.

User input data may be entered to the general editor S302. For example, a user may enter user data inputs in a GUI of the general editor, which is displayed on the display module 151 of the user equipment 100. In order to enter the user data inputs, the user may use the camera 121 or the microphone 122 of the A/V input unit 120, or the input unit 130, by using an interface such as a key button, a touch pad, or a keyboard.

The entered user input data may be stored in the data storage unit 211 automatically or in response to control of a user S303.

A list of applications to which the entered user input data can be transferred to from the general editor function may be provided S304. For example, a list of applications that can interact with the general editor function may be displayed on an area of the display module 151 in order to enable a user to visually check and select one of the applications that the user wants to use.

One of applications in the list may be selected and activated 5305. For example, a user may select one application from the list of applications. Then, the selected application may be activated in response to a selection signal generated by selecting the application. When the selected application is activated, a user interface of the selected application may be displayed on the display module 151. That is, the user interface of the general editor may be switched to a user interface of the selected application.

The entered user input data may be transferred to the selected application S306. For example, the entered user input data may be temporarily stored in the data storage unit 211, and the stored user input data may be transferred to the selected application.

The transferred user input data may be modified based on properties and functions of the selected application S307. For example, after transferring the user input data to the selected application, the user input data may be processed to be more compatible with the properties and functions of the selected application.

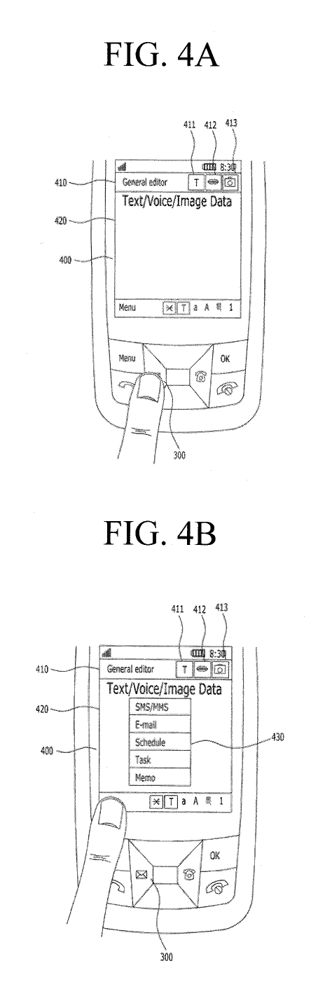

FIGS. 4A and 4B illustrate examples of supporting a general editor function in accordance with an embodiment of the present invention.

Referring to FIGS. 4A and 4B, a user equipment may include a keypad as a user input unit. In an embodiment of the present invention, an additional key may be employed in a user equipment in order to activate the general editor function, or any existing keys may be dedicatedly assigned to activate the general editor function. For example, a key button 300 provided for an SMS/MMS function may be used to activate the general editor function, as illustrated in FIG. 4A.

When the general editor function is activated as illustrated in FIG. 4A, a general editor graphical user interface (GUI) 400 of the general editor function is displayed on the display module 151. The general editor GUI 400 may include an editing tool 410 and a user data output window 420.

The editing tool 410 may enable a user to select a data input type. In order to select the data input type, the editing tool 410 may include a text data input icon 411, a voice data input icon 412, and an image data input icon 413. Based on the selection, one or more of the camera 121, the microphone 122, and the input unit 130 may be activated in cooperation with the general editor function.

After entering the user input data, an application list 430 may be displayed on an area of the display module 151 in response to a user control signal. The application list 430 may include applications that can interact with the general editor function. Accordingly, a user may select one application from the application list and use the user input data entered through the general editor function as an input signal of the selected application.

The application list 430 may include applications that use the same data input type selected by the user. Accordingly, applications in the application list 430 may be changed according to the data input type selected by the user.

Instead of using a keypad or a dome switch, a touch screen may be used to activate the general editor function when a user equipment employs the touch screen. Hereinafter, examples of supporting a general editor function using a user equipment having a touch screen will be described.

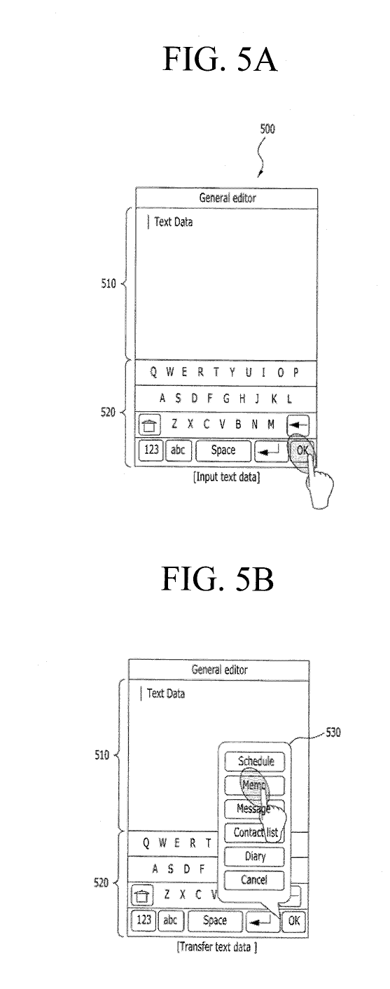

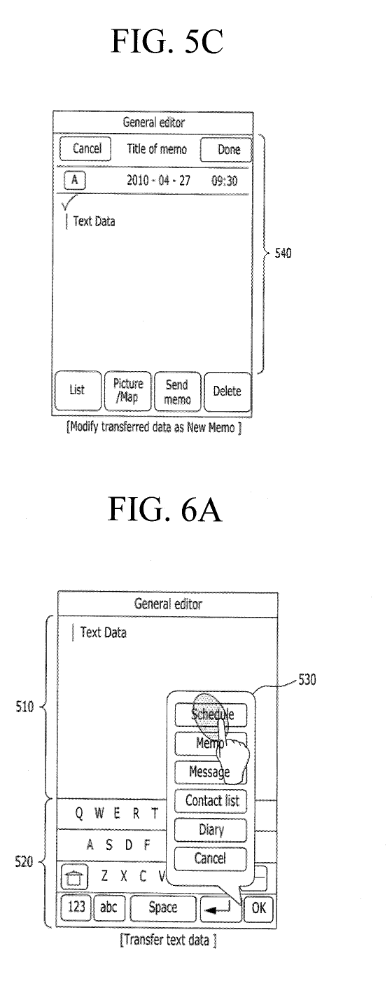

FIGS. 5A to 5C illustrate examples of supporting a general editor function, in accordance with another embodiment of the present invention.

As illustrated in FIGS. 5A to 5C, a user equipment may include a touch screen that has a layered structure of a touch sensor and a display module. Such a touch screen may be used as both an input device and an output device.

As illustrated in FIG. 5A, a general editor GUI 500 may be displayed on the touch screen of the user equipment when the general editor function is activated. The general editor GUI 500 may include a data output window 510 and a virtual keypad 520. A user may enter data using the virtual keypad 520. Then, the data output window 510 may output data that a user enters.

After a user enters data using the virtual keypad 520, an application list 530 may be displayed on an area of the touch screen, as illustrated in FIG. 5B. The application list 530 may include applications that can interact with the general editor function. A user may select and activate one application from the application list 530.

When a user selects and activates one application from the application list 530, the general editor GUI 500 may be closed and a GUI of the selected application 540 may be displayed on the touch screen as illustrated in FIG. 5C. After displaying the GUI of the selected application 540, the user data input entered through the general editor function may be transferred to the selected application as an input data.

For example, when a user wants to use user input data entered through the general editor function for a memo application, the user may select a memo application from the application list 530. Then, a GUI of the memo application may be displayed on the touch screen and the user input data entered through the general editor function may be transferred to the memo application. The GUI of the memo application may display the transferred user input data on a corresponding data output window thereof. Before the transferred user input data is displayed, the memo application may modify the transferred user input data to be suitable for the properties and functions of the memo application.

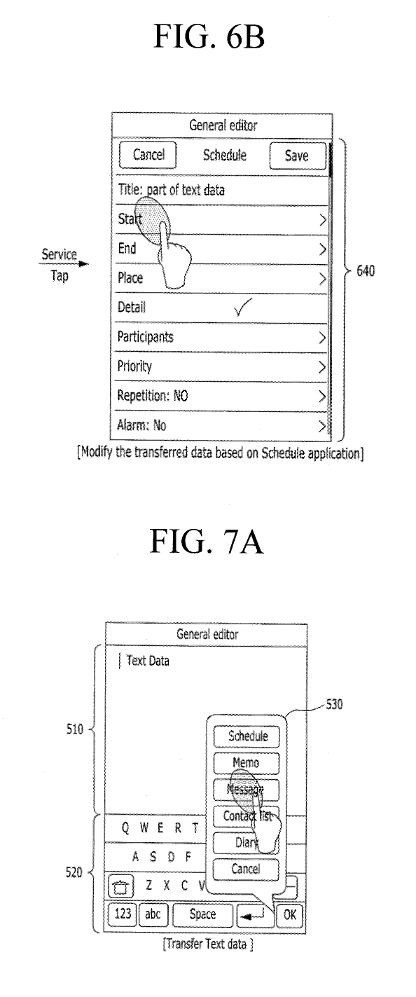

FIGS. 6A and 6B illustrate examples of supporting a general editor function, in accordance with another embodiment of the present invention.

Similar to the examples illustrated in FIGS. 5A to 5C, a user may select a schedule application from an application list 530 displayed on an area of a general editor GUI after entering a user input data through a general editor function, as illustrated in FIG. 6A.

In response to the selection of the schedule application, the general editor GUI may be closed and a GUI 640 of the schedule application may be displayed on a touch screen, as illustrated in FIG. 6B. User input data entered to the general editor GUI may be transferred to the GUI 640 of the schedule application. The user input data may be modified based on properties and functions of the schedule application, as illustrated in FIG. 6B.

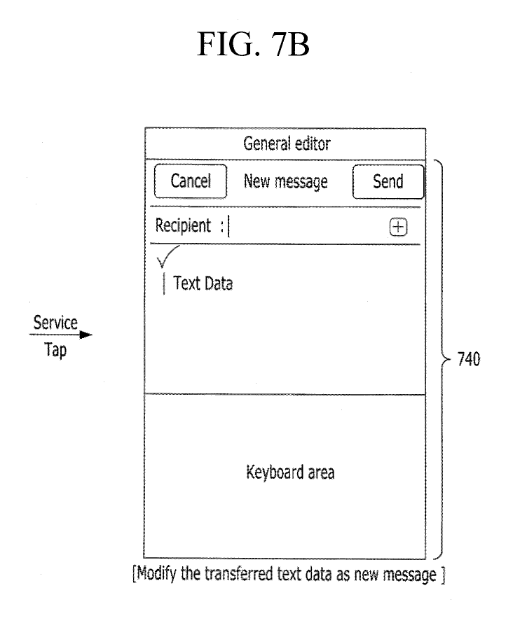

FIGS. 7A and 7B illustrate examples of supporting a general editor function, in accordance with another embodiment of the present invention.

User data input entered to a general editor function may be used for multiple applications. The general editor function may store user data input in the data storage unit 211 after using the entered user data input for a selected application. The user data input may be fetched from the data storage unit 211 and the fetched user data input may be output on the data output window 510 of the general editor GUI in response to a user control signal. Before fetching the user data input, a user may select a message application from an application list 530 as illustrated in FIG. 7A.

Accordingly, the general editor GUI may be closed, and a GUI of the message application 740 may be displayed on the display module 151. The fetched user data input may be transferred to the GUI of the message application 740 and modified based on properties and functions of the message application. As described above, the user input data stored in the data storage unit 211 can be reused for other applications after it is used for the selected application.

In accordance with embodiments of the present invention, the method for rotating an image displayed on a screen may be realized as a program and stored in a computer-readable recording medium such as a CD-ROM, a RAM, a ROM, floppy disks, hard disks, magneto-optical disks, and the like. Since the process can be easily implemented by those skilled in the art to which the present invention pertains, further description will not be provided herein.

The term “coupled” has been used throughout to mean that elements may be either directly connected together or may be coupled through one or more intervening elements.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for supporting a general editor function, the method comprising:
receiving user data input through the general editor function; and
transferring the received user data to at least one application.

2. The method of claim 1, wherein prior to transferring the received user data, the method further comprises:
providing at least one application list to a user from which the at least one application is selected,
wherein each application list of the at least one application list comprises at least one application that is capable of interacting with the general editor function to receive the transferred user data.

3. The method of claim 2, wherein:
each application list of the at least one application list is classified by an input type; and
the at least one application list comprises at least one of:
a text input related application list comprising at least one application configured to receive text as the user data;
a voice input related application list comprising at least one application configured to receive voice as the user data; and
an image input related application list comprising at least one application configured to receive an image as the user data.

4. The method of claim 1, wherein after receiving the user data, the method further comprises:
storing the received user data; and
fetching the stored user data,
wherein the at least one application is selected from at least one application list and the fetched user data is transferred to the selected at least one application.

5. The method of claim 4, wherein the fetched user data is transferred to a plurality of applications.

6. The method of claim 1, wherein after the received user data is transferred to the at least one application, the method further comprises:
modifying the transferred user data based on properties and functions of the at least one application.

7. A method for supporting a general editor function of a user equipment, the method comprising:
displaying a general editor user interface on a display module of the user equipment;
receiving user data input from a user through a data input window of the general editor user interface;
displaying an application list on the general editor user interface;
displaying, on the display module, a user interface of an application selected from the application list in response to a user selection signal; and
transferring the received user data to the selected application.

8. The method of claim 7, wherein after receiving the user data, the method further comprises:
storing the received user data in a memory; and
fetching the stored user data after displaying the user interface of the selected application; and
transferring the fetched user data to the selected application.

9. The method of claim 8, wherein the stored user data is fetched and transferred to a plurality of applications selected from the application list.

10. The method of claim 7, wherein the application list comprises at least one application that interacts with the general editor function.

11. The method of claim 10, wherein:
the application list is classified by an input data type; and
the application list comprises at least one of:
a text input related application list comprising at least one application receiving text as the user data;
a voice input related application list comprising at least one application receiving voice as the user data; and
an image input related application list comprising at least one application receiving an image as the user data.

12. The method of claim 7, wherein after transferring the user data to the selected application, the method further comprises:
modifying the transferred user data based on properties and functions of the selected application.

13. An apparatus for supporting a general editor function, the apparatus comprising:
a display module configured to display a general editor user interface of the general editor function; and
a general editor module configured to receive user data from a user through a data input window of the general editor user interface, and configured to transfer the user data to at least one application selected from at least one application list.

14. The apparatus of claim 13, further comprising:
a button configured to receive an activation signal for activating the general editor function; and
an input unit which, in integration with the data input window of the general editor user interface, is configured to receive the user data from the user,
wherein the input unit comprises at least one of a camera, a microphone, a touch pad, a keypad, and a dome switch.

15. The apparatus of claim 13, wherein:
the display module comprises a touch screen, and a general editor icon is displayed on an area of the display module as an activation key for activating the general editor function.

16. The apparatus of claim 13, further comprising:
a data storage unit configured to store the user data received through the general editor user interface; and
an application group comprising a plurality of application modules each controlling an operation for a corresponding application.

17. The apparatus of claim 16, wherein the general editor module is configured to:
store the received user data in the data storage unit;
fetch the stored user data; and
transfer the fetched user data to at least one application.

18. The apparatus of claim 13, wherein the general editor module is configured to:
display an application list on the general editor user interface;
receive a selection signal from the user to select the at least one application from the at least one application list;
transfer the received user data to the selected at least one application; and
display a user interface of the selected at least one application along with the transferred user input data,
wherein the transferred user data is modified based on properties and functions of the selected at least one application.

19. The method of claim 13, wherein the user data is transferred to a plurality of applications selected from the at least one application list.

20. The apparatus of claim 13, wherein:
each application list of the at least one application list comprises at least one application classified by an input data type; and
each application list of the at least one application list comprises at least one of:
a text input related application list comprising at least one application configured to receive text as the user data;
a voice input related application list comprising at least one application configured to receive voice as the user data; and
an image input related application list comprising at least one application configured to receive an image as the user data.
